(19) United States
(12) Patent Application Publication
(10) Pub. No.: US 2010/0231708 A1
(43) Pub. Date: Sep. 16, 2010

(54) Method of, and Apparatus for, Measuring the Quality of a Surface of a Substrate

(75) Inventor: Roy Ronald Rosenberger, Appleton, WI (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: VERITY IA, LLC, Appleton, WI (US)

(21) Appl. No.: 12/293,820

(22) PCT Filed: Nov. 17, 2006
(86) PCT No.: PCT/IB2006/004311

§ 371 Date: Nov. 6, 2008

Related U.S. Application Data
(60) Provisional application No. 60/743,615, filed on Mar. 21, 2006.

(51) Int. Cl. H04N 7/18

(52) U.S. Cl. 348/128; 348/E07.091

(57) ABSTRACT

A method of measuring the quality of a surface of a substrate is described. The method includes the steps of obtaining a digital image of a portion of a surface of the substrate using an image obtaining apparatus; and measuring one or more physical characteristics of the obtained digital image so as to provide an indication of the quality of the surface of the substrate.

### TECHNICAL FIELD

This invention relates to a method of, and apparatus for, measuring the quality of a surface of a substrate, and more particularly to a surface of a substrate onto which an image is to be printed.

### BACKGROUND OF THE INVENTION

The quality of a printed image is dependent on a number of variables, such as printing pressure, ink viscosity and temperature, and these are commonly the responsibility of a press operator, who employs subjective evaluation of the quality of the printed image and adjusts these variables accordingly until the quality of the printed image is satisfactory.

However, in addition to those variables that the operator can control, the uniformity of the surface of a substrate onto which the image is printed will also affect the quality of the printed image. For example, in impact printing the quality of the printed image depends principally on the smoothness or roughness of the surface and the uniform distribution of the smoothness/roughness onto which the image is transferred. The uniformity of smoothness spatial distribution is perhaps the most important aspect in the transfer of ink onto a substrate. High and low points on the surface of the substrate will receive more or less ink depending upon their relative height (or depth). Any non-uniformity in the ink transfer will be recognized by the human eye as mottle (i.e. patchiness) and, in printed text or characters, as poor character formation and/or edge definition.

The present invention has been devised particularly for substrates such as coated paper and board (e.g. heavier and thicker grades of paper) which are used in “contact” printing methods (e.g. offset, rotogravure, flexography, and others where the plate bearing the ink contacts the surface onto which the ink is transferred), although it must be appreciated that the present invention could be used to measure the quality of any substrate onto which an image is to be printed, irrespective of the method with which the image is to be transferred onto the surface of the substrate. It may also be employed to measure the quality of embossed or engraved surfaces of any type.

A prior art test of the surface quality of a substrate has been to print onto the substrate an image and then evaluate the quality of the printed image. However, this is an expensive and time consuming procedure, the results of which are related entirely to the particular batch of paper tested at that time. For these reasons a manufacturer of the substrate would prefer to a test which could measure the quality of any given substrate of any batch before an image is printed thereon.

Various methods have been developed to predict printing performance by analysing the surface of the substrate. In one method the substrate is held between a pair of parallel metal plates. Air, at a known pressure, is then forced from one end of the substrate to the other, and the pressure at the other end of the substrate is measured. The result of this test is purported to indicate the roughness (or smoothness) of the surface of the substrate. However, such a method has disadvantages, namely that it highlights a particular region of surface roughness, and cannot average across the entire substrate, and as a result would not necessarily locate all regions of surface roughness, if those regions were small in comparison to the overall area of the substrate being tested. These devices can only measure local roughness in very small areas and thus provide no indication of the uniform distribution of roughness in the larger specimen area.

In another method a profile measurement device is utilised, which incorporates laser technology to measure surface roughness. Such devices are limited to measuring very small areas, sometimes as small as one square centimeter, and, as a result, in production quality control, they have been found unable to predict reliably the quality of a surface of a substrate. This is because printing machines often use substrates having a width of 2 meters or more, and thus a test area of one square centimeter is not substantial enough.

It is therefore an object of the present invention to provide a method of, and apparatus for, measuring the quality of a surface of a substrate, so that a prediction of the quality of an image to be printed onto the substrate can be made prior to printing the image onto the substrate.

### BRIEF SUMMARY OF THE INVENTION

Therefore according to an aspect of the present invention there is provided a method of measuring the quality of a surface of a substrate, including the steps of: obtaining a digital image of a portion of a surface of the substrate using an image obtaining apparatus; and measuring one or more physical characteristics of the obtained digital image so as to provide an indication of the quality of the surface of the substrate. The method may include the step of illuminating, at an angle to a general plane of the substrate, the portion of the surface of the substrate prior to the digital image being obtained.

The obtained digital image may include a plurality of pixels and the method may include measuring, for a test area of pixels within the obtained digital image, a physical characteristic of each pixel and comparing the measured physical characteristic of each pixel within the test area with the measured physical characteristic of an adjacent pixel. The physical characteristic measured may be a luminance of each pixel.

The method may include comparing the measured physical characteristic of each pixel within the test area with the measured physical characteristic of two or more adjacent pixels.

The test area of pixels within the obtained digital image may include a plurality of pixels in rows and columns and the method may include comparing the measured physical characteristic of each pixel within the test area with the measured physical characteristic of a first adjacent pixel located in the same row and with the measured physical characteristic of a second adjacent pixel located in the same column.

The method may include comparing the measured physical characteristic of each pixel within the test area with the measured physical characteristic of an adjacent pixel located in an adjacent row or column.

The method may include measuring for a test area of pixels within the obtained digital image, a physical characteristic of a group of adjacent pixels and comparing the measured physical characteristic of that group of pixels with the measured physical characteristic of an adjacent group of pixels. The measure physical characteristic may be an average luminance of each group of adjacent pixels.

Where the obtained digital image is a colour digital image, e.g. a 24 bit colour digital image, the method may include the step of converting the colour digital image to a gray-scale digital image, e.g. an 8 bit digital image, before a physical characteristic of each pixel of the digital image is measured.

The method may include the step of measuring for the test area of the digital image the average pixel luminance value and the standard deviation of the luminance values for all of the pixels in the test area.

Alternatively, the colour digital image may be separated into each of its component parts, e.g. Red, Green and Blue light, to produce three separate component part gray-scale digital images, each being an 8 bit gray-scale digital image. In this case the method may include the step of measuring for the test area of each of the component part gray-scale digital images the average pixel luminance value and the standard deviation of the luminance values for all of the pixels in the test area.

The method may include the subsequent step of selecting for further analysis the gray-scale digital image with the largest pixel luminance standard deviation. The digital image with the largest pixel luminance standard deviation usually will provide a more accurate assessment of the quality of the surface of the substrate, as a larger pixel luminance standard deviation represents a wider range of luminance values for the pixels in the test area. Contamination of the image by foreign or tramp materials such as lint may yield uncertain results for the standard deviation calculation, and thus the presence of such materials should be avoided.

The Blue light component part gray-scale digital image may not used for further analysis if the substrate contains a brightening agent, and instead either of the Red or the Green light component part gray-scale digital images may be used. Preferably the component part gray-scale image used is the one with the largest pixel luminance standard deviation.

The method may include the step of enhancing the gray-scale digital image. In one example, the luminance value for each pixel within the test area of the gray-scale digital image is adjusted if the luminance value of that pixel differs from an average luminance value for all of the pixels within the test area of the gray-scale digital image. Enhancement of the gray-scale image may also include adjusting the luminance value for each pixel within the test area by a multiplying factor. The multiplying factor may, for example, be determined by the arithmetic distance of the luminance value of each pixel from the mean pixel luminance value of all of the pixels in the test area of the gray-scale digital image.

The method may include the step of adjusting the luminance value for each pixel in the test area so as to spread the pixel luminance values of all of the pixels in the test area substantially evenly throughout the visible range. In an 8-bit digital image that range is pixel luminance values of between 0 to 255, where 0 is black and 255 is white. The resultant digital image is often referred to as a mono-chromatic image, and may be higher or lower than 8-bit, e.g. 4, 12 or 16-bit.

The method may include the step of providing on a viewable output a digital display of the enhanced gray-scale digital image. A user can then view the enhanced digital image, which will show regions of the surface of the substrate which are higher/lower than other regions of the surface of the substrate. If the displayed digital image does not clearly show the high/low regions of the surface of the substrate, the method may include the step of enhancing the digital image further. Enhancement of the digital image may be performed any number of times as desired by the user, until high/low regions of the digital image are visible to the user.

The method may include the step of providing a viewable output indicative of the quality of the printed image. The viewable output may include a numerical value (hereinafter referred to as the “topographic number”) which indicates to a user the quality of the surface of the substrate.

According to a second aspect of the present invention there is provided an image obtaining apparatus, the apparatus including: —a device to obtain a digital image of a portion of a surface of a substrate; a storage device to store information relating to the obtained digital image; and a device to measure one or more physical characteristics of the obtained digital image so as to provide information indicative of the quality of the substrate, wherein the apparatus also includes a light source for illuminating the portion of the surface of the substrate, so as to cast shadows over the surface of the substrate at or near regions of the surface of the substrate which are uneven.

Examples of the invention will now be described by way of example only with reference to the accompanying drawings, of which:

### BRIEF DESCRIPTION OF THE DRAWINGS

FIG. 1 is a digital image of a portion of a surface of a substrate;

FIG. 2 is an enhanced digital image based on the digital image of FIG. 1;

FIG. 3 is a histogram of pixel luminance values for an image produced by averaging the Red, Blue and Green light component parts of the digital image of FIG. 1;

FIG. 4 is a histogram of pixel luminance values for an enhanced digital image based on the digital image of FIG. 1;

FIG. 5 is a histogram pixel luminance values for the digital image of FIG. 2;

FIG. 6 is an illustrate view of a part of the calculation performed to obtain a topographic number, i.e. surface roughness, of the surface of the substrate of FIG. 1;

FIG. 7 is a view of a notional pixel target area for use in the method of the present invention;

FIG. 8 is a flow chart of a method in accordance with the first aspect of the present invention; and

FIG. 9 is a diagrammatic illustration of an image obtaining apparatus in accordance with the second aspect of the present invention.

### DETAILED DESCRIPTION OF THE INVENTION

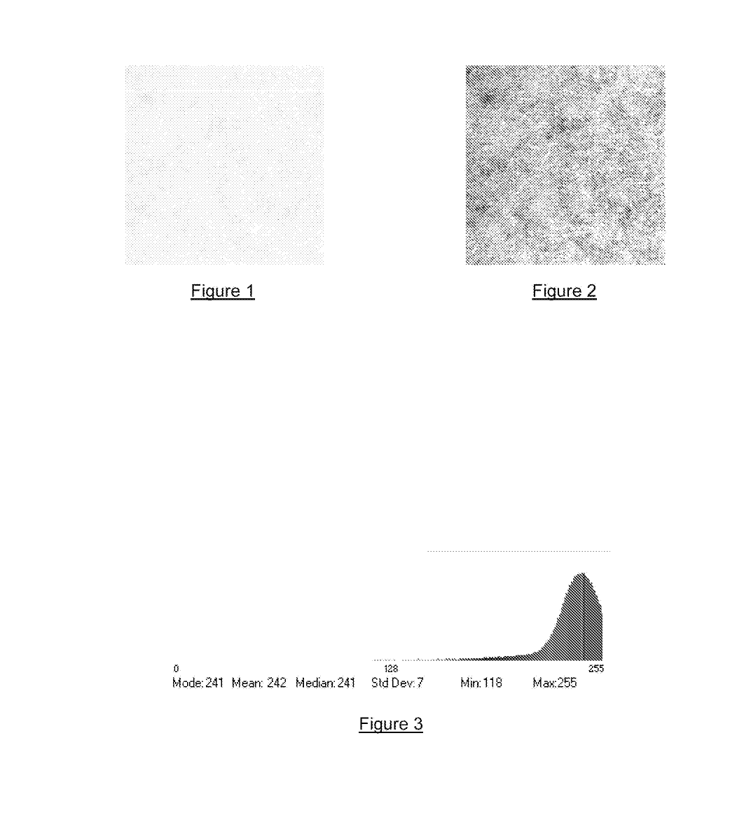

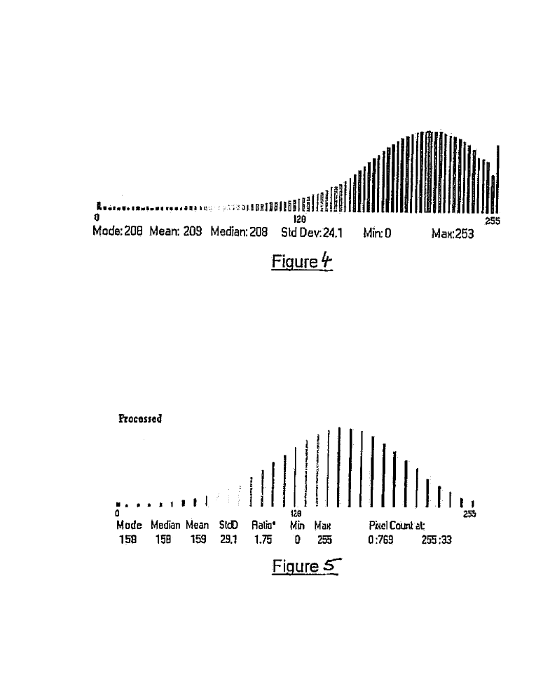

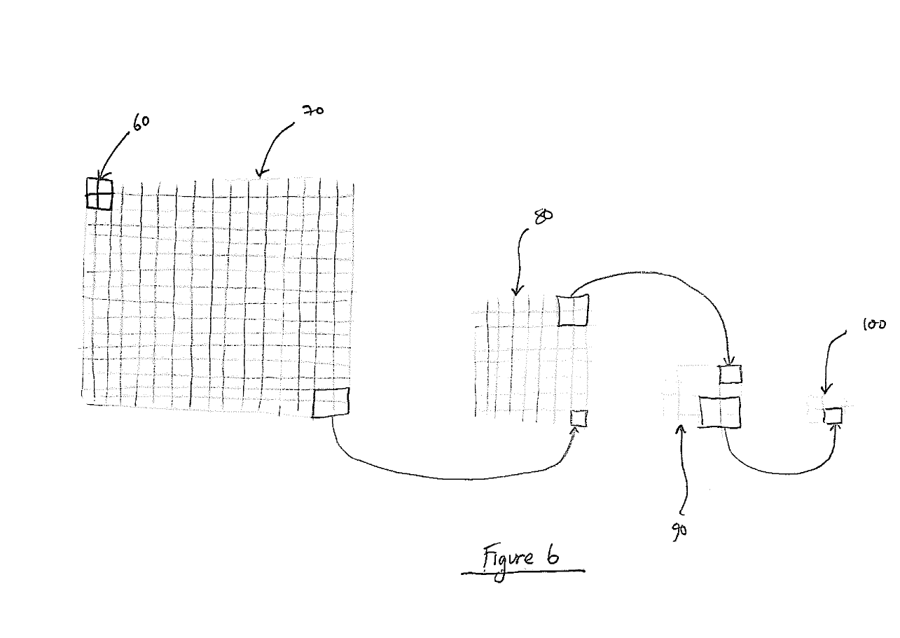

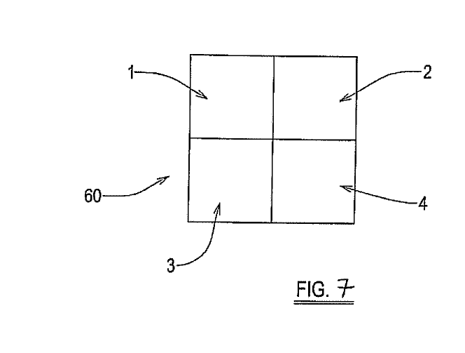

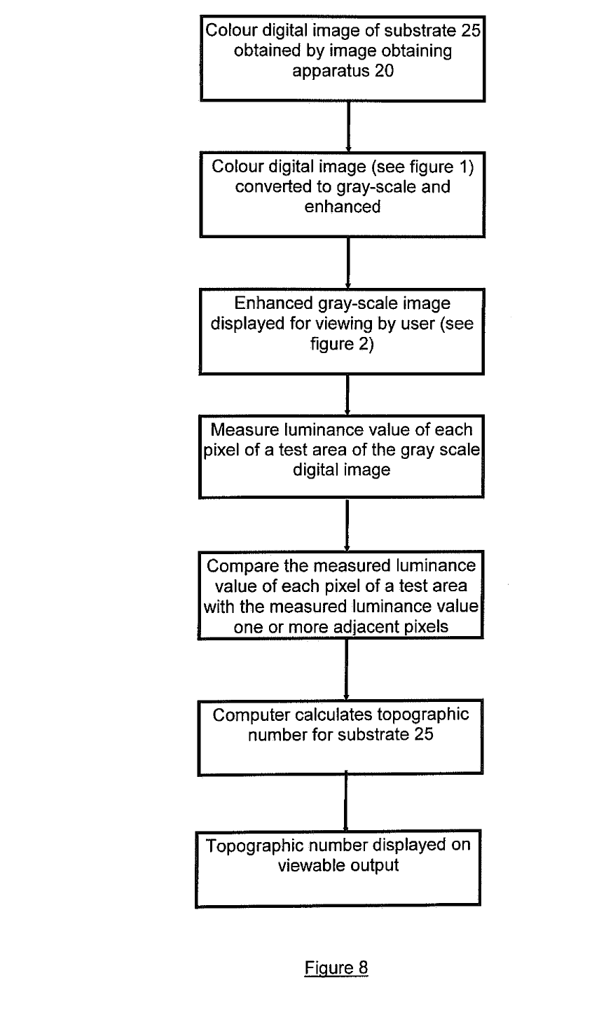

FIG. 1 is a digital image of a portion of a surface of a substrate 25, obtained by an image obtaining apparatus 20 (as shown in FIG. 12). The image of FIG. 1 (discussed in greater detail later) is a typical example of an area of a white sheet of paper, the surface of which appears, to the unassisted human eye, to be relatively featureless and uniform. However, the surface of the white sheet of paper is not smooth, and this can have a detrimental affect on quality of an image printed onto the substrate 25. Thus it would be beneficial to determine the roughness of the surface of the substrate 25 and how uniformly distributed that roughness is. The method in accordance with the present invention can be used to assess the quality of the surface of the substrate 25, and to reveal surface roughness which is not visible to the human eye.

The apparatus 20 is a digital scanner which includes a housing 21 with an opening in its upper surface which is covered by glass or a transparent plastic 23 onto which a substrate 25 to be tested is positioned and held in place by a weight 26. The apparatus 20 includes a plurality of image sensors 27, such as CCD (Charge-Coupled) or CMOS (Complimentary Metal-Oxide Semiconductor) image sensors. Each image sensor 27 is a collection of tiny light-sensitive diodes or photosites, which convert light into an electrical charge. In use, the image sensors 27 are supported on a structure which is moveable relative to the substrate 25, so that an image can be obtained which is larger than the area of the image sensors 27. Such a configuration is well known in the art.

The apparatus 20 also includes a power source 28 and a light source 29, the purpose of the latter being to illuminate, at an angle, preferably about 450, to a general plane of the substrate 25, an area of the surface of the substrate 25 to be tested. Illumination of the surface of the substrate 25 by the light source 29 casts shadows over the surface of the substrate 25 at or near regions of the surface of the substrate 25 which are uneven (e.g. shadows will be cast over regions of the surface of the substrate 25 which are lower than adjacent regions). Such shadows, although imperceptible to the naked eye, will be sensed by the photosites 27 and thus recorded in the obtained digital image by a decrease in the luminance value of pixels in the region of the shadow.

The image obtaining apparatus 20 in this example is capable of obtaining a digital image at a resolution of at least 600 ppi (pixels per inch) in either full colour or gray-scale. It must, however, be appreciated that an image obtaining apparatus 20 capable of obtaining a lower or higher resolution of digital image could also be used.

The image obtaining apparatus 20 is connected to a computer (not shown), which is programmed to manipulate information received from the image sensors 27 and to covert that information into a stored digital image (the image of FIG. 1), which is, preferably, shown on a digital screen (not shown) for viewing by a user.

In this example, the image of FIG. 1 is a 24-bit 600 ppi (pixels per inch) colour image (although the image of FIG. 1 is a gray tone reproduction thereof). In this example, in order to assess the quality of the surface of the substrate 25 it is necessary to convert the 24-bit colour image to a gray-scale digital image, e.g. an 8 bit digital image. A gray-scale digital image is one in which the absolute light reflectance (luminance) value of each pixel, regardless of its originating colour before conversion, ranges from 0 to 255. A pixel luminance value of 0 (zero) is black and a pixel luminance value of 255 is white. Varying shades of gray have values between 1 and 254. Thus, once converted to a gray-scale image, the originating colour of each pixel has no effect on the assessment of the image. If the colour image was used, an area of dark blue, for example, may be interpreted, in correctly, as a trough in the surface of the substrate, if that area of dark blue was surrounded by a lighter colour. This would give poor and unreliable results.

Conversion of the colour image to a gray-scale image can be performed by either extracting colour from the colour digital image to provide an 8-bit gray-scale image, or by the 24-bit colour digital image being separated into each of its component parts, e.g. Red, Green and Blue light component parts, to produce three separate gray-scale digital images, each being an 8-bit gray-scale digital image.

Many substrates include a brightening agent, e.g. a form of chemical pigment, which is excited by ultra-violet light to emit visible Blue light. This pigment gives the substrate the appearance of being bright and clean, i.e. smooth and not rough, due to the Blue light being reflected back to the photosites 27 of the image obtaining apparatus 20. When using the combined gray-scale digital image, obtained by simple colour extraction from the original 24-bit colour digital image, the brightening agent will have a detrimental effect on measuring the quality of the substrate, as it will tend to ‘hide’ many of the undulations in the surface of the substrate 25.

Therefore, in order to avoid this problem, if the substrate 25 includes a brightening agent, the Blue light component part gray-scale 8-bit digital image is not used for further analysis, and either of the obtained Red or Green component part gray-scale digital images is used.

If it is not known whether the substrate to be tested includes a brightening agent, an analysis of the Blue light component part should highlight whether a brightening agent is present. This will be revealed by the Blue light component part gray-scale digital image having a pixel luminance standard deviation which is much lower than that of the pixel luminance standard deviation of the Red or Green light component gray-scale digital images.

If the substrate 25 includes a brightening agent, the computer would have to determine which of the Green or Red light component gray-scale digital image should be used for further processing. This would be determined by comparing the pixel luminance standard deviation for each of the Green and Red light component part gray-scale digital images. The component part gray scale digital image which has the largest pixel luminance standard deviation should provide a more accurate the measurement of the quality of the surface of the substrate 25, because a larger pixel luminance standard deviation represents a wider range of luminance values for the pixels in the digital image, and thus a greater difference between high and low regions of the surface of the substrate 25.

In this example, however, in order to measure the quality of the portion of the surface of the substrate 25 as shown in the image of FIG. 1, the image of FIG. 1 is firstly converted to an 8-bit gray-scale digital image. This is achieved by averaging the Red, Blue and Green light component parts, as no brightening agent is present in the substrate 25. A histogram of the image produced by averaging the Red, Blue and Green light component parts of FIG. 1 is shown in FIG. 3.

It is common in a gray-scale digital image for the luminance values of the pixels making up the digital image to be consecutive, i.e. the gray-scale digital image includes at least one pixel at having a luminance value at each integer pixel luminance value of between 0 (zero) and 255. It is difficult for the human eye to distinguish between pixels having luminance values which are numerically similar. For example, a human eye would find it impossible to distinguish between pixels having luminance values of 150 and 151.

Therefore, it is beneficial when measuring the quality of the surface of the substrate 25, although not essential, to enhance the gray-scale digital image (as obtained from the image of FIG. 1) to make more visible within the gray-scale digital image high/low regions of the surface of the substrate 25. The method of the present invention achieves this by adjusting the luminance value for each pixel using the following calculation: —

NV=OPLV+((OPLV−OMPLV)×IV)+MS (1)

### Where:

### NV=New Pixel Luminance Value;

### OPLV=Original Pixel Luminance Value;

OMPLV=Original Image Mean Pixel Luminance Value; IV=interpolation Value; and
MS=Mean Shift Value (see below).

The Mean Shift Value in the above calculation adjusts, or ‘shifts’, the Mean Pixel Luminance Value towards the middle of the visible range (i.e. somewhere roughly halfway between 0 and 255) and is calculated in the following way: —

MS=IV×((MPLV−255)+1) (2)

### Where

### MS=Mean Shift Value; and

### MPLV=Mean Pixel Luminance Value.

If the Mean Shift is not performed the luminance value of some pixels of the gray-scale digital image, once adjusted, would overflow at the upper or lower ends of the visible range. For example, if a pixel's luminance value is adjusted to more than 255, it will appear on the digital image as white, irrespective of whether its pixel luminance value was adjusted to 256 or 270. It is necessary to minimise, and preferably to avoid completely, overflow in this way, as this loses useful data, which cannot later be utilised to measure the quality of the surface of the substrate 25. The Interpolation Value must be chosen carefully by the user. The larger the Interpolation Value used, the greater the enhancement of the digital image. However, too large an Interpolation Value will also result in overflow for some pixels, and thus the Interpolation Value must be carefully chosen.

As an example, when performing the Mean Shift of calculation (1) on the gray-scale image digital image (as obtained from the image of FIG. 1), with an Interpolation Value of seven, the histogram of FIG. 4 is produced. This histogram will not be very useful in measuring the quality of the surface of the substrate 25, as the pixel luminance values are still relatively closely packed and the mean average luminance value of 209 is not close enough to the middle of the visible range, meaning that the pixel luminance values are not adequately spread across the entire visible range.

When calculation (2) is performed the histogram of FIG. 5 and the digital image of FIG. 2 are produced. It is clear from the new histogram of FIG. 5 that there are large gaps between adjacent pixel luminance values and that the pixel luminance values are spread across the entire visible range. For example, a pixel having, say, a luminance value of 150 may be present, but no pixels have a luminance value of 145 to 149 or 151 to 155 are present. The new digital image of FIG. 2 thus reveals to a user more adequately high/low regions of the surface of the substrate 25 which are not visible from the digital image of FIG. 1. Furthermore, using an Interpolation Value of seven does not result in any overflow at the upper or lower ends of the visible range as is also clear from the enhanced digital image of FIG. 2 which does not have large areas of white or black.

Once the image of FIG. 1 has been enhanced to produce the image of FIG. 2, the computer displays the enhanced digital image of FIG. 2 on a viewable output, such as a computer monitor (not shown), so that a user can see whether the digital image has been enhanced to a desired amount. If the user chooses too high an Interpolation Value, large areas of the new digital image would appear white or black with very little gray areas shown, which would not be helpful. Thus, choosing an appropriate Interpolation value for each specific test is one of trial and error.

If the displayed digital image does not adequately show the high/low regions of the surface of the substrate, the digital image can be re-enhanced, e.g. by reapplying the above calculations (1) and (2) to the gray scale digital image obtained from the image of FIG. 1 using a different Interpolation Value.

Of course, although it would be possible to use an un-enhanced gray-scale digital image to measure the quality of the surface of the substrate 25, the results obtained as to the quality of the surface of the substrate 25 would often be numerically too small such that no meaningful indication can be gained as to the quality of the surface of the substrate. Enhancement of the gray-scale digital image prior to its assessment by the computer is therefore beneficial. It must be appreciated, of course, that other techniques could be used to enhance the quality of the gray-scale digital image.

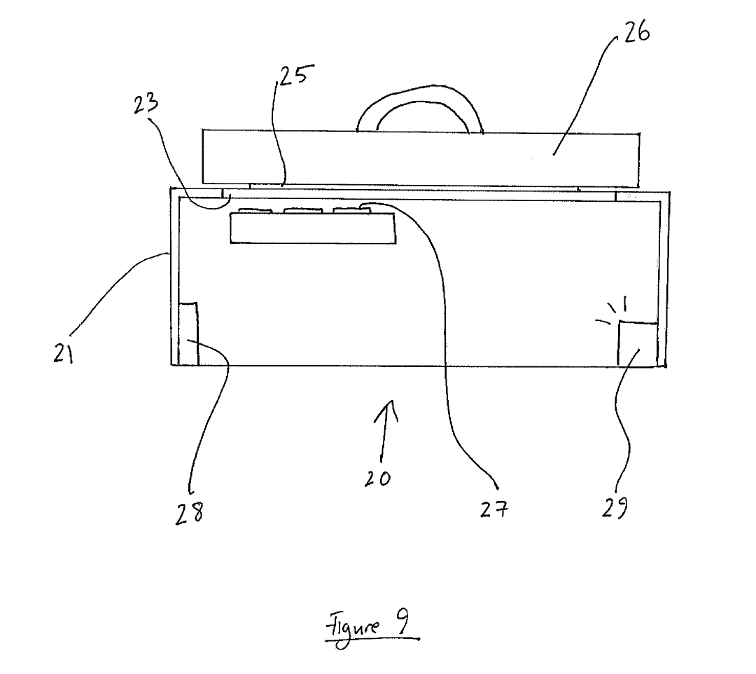

Once the gray-scale digital image has been enhanced, and is acceptable to the user as displayed, the computer then assesses the enhanced gray-scale digital image to measure the quality of the surface of the substrate. This is performed as follows (see FIG. 8).

The computer measures the luminance value of pixels within a test area of the enhanced digital image of FIG. 2 and compares the luminance value of adjacent pixels with each other to determine the quality of the surface of the substrate. The test area is preferably a rectangular area within the enhanced gray-scale digital image which has x number of pixel columns and y number of pixel rows. However, any shape of test area could be used.

It has been found that the method of the present invention provides accurate results when analysing a digital image where each pixel thereof measures 0.168 mm by 0.168 mm (i.e. 150 ppi). Thus, when starting from the enhanced digital image of FIG. 2, which has a resolution of 600 ppi (.i.e. each pixel being 0.042 mm by 0.042 mm), it is necessary to rescale the image until the pixel size is reduced to 0.1695 mm by 0.1695 mm, and this is achieved by creating a ‘base’ digital image 70 (see FIG. 6) as follows. The ‘base’ digital image 70 is created by averaging the luminance values of groups of adjacent pixels within the test area of the enhanced digital image to produce a smaller digital image by calculating the mean average of the pixel luminance values for each array of 16 pixels, e.g. each array measuring 4 by 4 pixels, within the test area and storing the results in a memory facility of the computer. The results define the ‘base’ digital image 70, which is one sixteenth the size, in number of pixels, of the enhanced digital image of FIG. 2.

Of course, instead of rescaling the image of FIG. 2, the original image of FIG. 1 could be obtained in a lower resolution equivalent to a pixel size of 0.1695 mm by 0.1695 mm (i.e. 150 ppi). However, this would result in useful data being lost, as the image sensors 27 of the apparatus 20 would miss important changes in luminance value of the surface of the substrate 25. Obtaining a higher resolution image and then rescaling, or averaging, the pixel luminance values for groups of pixels provides a more accurate representation of the surface of the substrate 25.

The computer then compares the luminance value of each pixel within the ‘base’ digital image 70 with the luminance value of its adjacent pixels, using a notional target area 60 (see FIG. 7). The target area 60 is two by two pixels in size and includes four pixel locating areas, which are labelled as 1 (positioned top left), 2 (top right), 3 (bottom left) and 4 (bottom right). The target area 60 could alternatively include only two pixel locating areas, e.g. pixel locating areas 1 and 2, or pixel locating areas 1 and 3. Alternatively still, the target area 60 could include three pixel locating areas, e.g. being L-shaped and including only pixel locating areas 1, 2 and 3.

The computer uses the notional target area 60 to define which pixels of the test area are to be compared with each other in a single operation. In each operation the luminance value of each of the pixels falling in the notional target area 60 are measured and compared with each other.

In this example, the computer starts at the upper left hand corner of the test area of the image and moves the target area 60 rectilinearly along each pixel row of the ‘base’ digital image 70, or alternatively each pixel column of the ‘base’ digital image 70, until the target area 60 reaches the end of that row or column. The computer then moves the target area 60 back to the start of an adjacent row or column and moves the target area 60 along that row or column. Thus the computer measures and compares virtually every possible array of 2 by 2 pixels within the test area.

The computer places the pixel locating area 1 on all but one row of pixels and on all but one column of pixels of the ‘base’ digital image 70. This is because for one pixel row and one pixel column at an edge of the ‘base’ digital image 70, a pixel falling in the pixel locating area 1 could only be compared with one adjacent pixel. Although such a comparison could be made in accordance with the method of the present invention, e.g. by using a notional target having only two pixel locating areas, either side by side or one on top of the other, it would not be consistent with the comparisons made throughout the remainder of the ‘base’ digital image 70.

The computer then calculates the difference between the luminance value for the pixel falling in the pixel locating area 1 and the luminance values for the pixels falling in the pixel locating areas 2, 3 and 4, for each 2 by 2 pixel array. In this example, one of two calculations can be used, although it must be appreciated that any other appropriate calculation could be used. The first calculates for each 2 by 2 pixel array the sum of the absolute differences between the luminance values of the pixels falling in pixel locating areas 1, 2, 3 and 4 using the following equation: —

=(abs(1−2)+abs(2−4)+abs(4−3)+abs(3−1)+abs(1−4)+abs(3−2)) (3)

The second calculates the sum of the absolute cross differences between the luminance values of the pixels diagonally adjacent each other (i.e. the difference between the luminance values for the: pixels falling within the pixel locating areas 1 and 4, and the difference between the luminance values for the pixels falling within the pixel locating areas 2 and 3) using the following equation: —

=(abs(1−4)+abs(2−3)) (4)

The term “abs”, an abbreviation for “Absolute”, as used in the above equations has its usual mathematical meaning, i.e. abs(x−y)=✓((x−y)2).

The difference calculations highlight whether the pixel luminance values for the pixels in each 2 by 2 pixel array differ greatly. If the difference calculation is large, this indicates an edge of an area of roughness. If the difference calculation is small, this indicates that no or little roughness exists at that location of the substrate 25. In other words, the difference calculations will differentiate between a “mountain” and a “mole hill” in terms of the roughness of the substrate at that 2 by 2 pixel array.

Results obtained by the computer using either of the above equations could be used without affecting the overall assessment of the quality surface of the substrate 25.

The computer then stores in a first area of its memory facility the results of the difference calculation for each 2 by 2 pixel array. As a separate function the computer also calculates the average luminance value for the four pixels in each 2 by 2 pixel array, and stores this in a second area of the its memory facility.

At the completion of these two calculations the computer moves the notional target area 60 onto the next adjacent pixel in that row or column as the case may be, where the computer makes the difference calculation, records the result in its memory facility and moves on, etc. The results are, for example, saved in the computer's memory facility in tabular form with each entry from a pixel location in the ‘base’ digital image 70.

Once the target area 60 has been moved over the entire ‘base’ digital image 70, the computer uses the tabulated data in the first area of its memory facility to calculate the standard deviation (hereinafter referred to as “SD1”) and the mean average (hereinafter referred to as “AVE1”) of the obtained absolute difference (or absolute cross difference) luminance values for the pixels within the ‘base’ digital image 70. These are stored in a third area of the computer's memory facility.

The computer then uses the results in the second area of its memory facility to create a new digital image 80, which is one quarter the size of the ‘base’ digital image 70 (see FIG. 6). The computer also calculates the standard deviation (hereinafter referred to as “SD2”) of the luminance values for all the pixels within the new digital image 80, and this is also stored in the computer's memory facility.

The topographic number, which indicates to the user the quality of the surface of the substrate 25, is then calculated as follows: —

Topographic Number=SDI×AVEI×SD2 (5)

and this is displayed on the computer monitor for consideration by the user.

The value of the AVE1 term relates to the rate of change of surface roughness (i.e. Are the peaks/troughs high and of steep gradient or are the peaks/troughs low and of shallow gradient?) of the digital image 70, whereas the value of the SDI term shows how much uniformity exists in the value of the AVEI term. Thus the product of these two terms provides an indication as to the surface roughness of the substrate. The SD2 term relates to the uniformity of the luminance values of the pixels within the digital image 80 (i.e_ the uniformity of each 2 by 2 pixel array of the digital image 70), and including this term in the topographic number calculation has the effect of regulating the highly responsive SDI term. The inclusion of the SD2 term also renders the SDI and AVEI terms responsive to spatial distribution.

The topographic number could be obtained by calculating the product of AVEI and SDI terms only, but this would not be as accurate as equation (5) above.

A topographic number of 0 (zero) indicates that the surface of the substrate, whether rough or smooth, is uniform (i.e. any roughness is uniformly distributed over the surface of the substrate), whereas a large topographic number indicates the opposite, namely that any roughness of the surface is not uniformly distributed. The topographic number, in combination with the displayed enhanced digital image, can be used by the operator to determine whether the quality of the substrate is good enough and thus whether an image printed thereon will be of good quality. If the topographic number is not within a desired range, a new test sample is taken from another part of the substrate and then tested. If all further samples (usually five are taken) result in topographic numbers which are not within the desired range, then it may be decided that the substrate from which the test sample was taken cannot be used.

There is no upper limit to the topographic number. In practice, the range of acceptable topographic numbers is determined by a set of specimens from a batch of substrates and thus topographic numbers, for example, of 101 and 157 may well be acceptable for a given substrate. Adjustments to the colour extraction, enhancement and re-scaling of the obtained digital image will affect the topographic number. Thus the topographic number is useful for comparison purposes between different substrates (i.e. a control substrate and a test substrate) where the above-mentioned variables are kept constant.

In order to obtain a more accurate topographic number for the surface of the substrate 25, the above method could be repeated using the digital image 80 as the ‘base’ digital image. This will eventually create an even smaller digital image 90 (see FIG. 6), which is one quarter the size of the digital image 80, and a topographic number can be calculated from the results obtained using calculation (5). The method can be repeated further still until the image to be used as the ‘base’ digital image comprises only 4 pixels (see digital image 100 in FIG. 6). The topographic number is then calculated as the mean average of all of the topographic numbers obtained in respect of each ‘base’ digital image.

In practice, however, the topographic number calculation is only performed on three ‘base’ digital images and, in the present example, the topographic number is calculated as the mean average of each of the topographic numbers calculated for the images 80, 90 and 100 (see FIG. 6).

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of measuring the quality of a surface of a substrate, including the steps of: —
obtaining a digital image of a portion of a surface of the substrate using an image obtaining apparatus; and measuring one or more physical characteristics of the obtained digital image so as to provide an indication of the quality of the surface of the substrate.

2. A method according to claim 1 including the step of illuminating, at an angle to a general plane of the substrate, the portion of the surface of the substrate prior to the digital image being obtained.

3. A method according to claim 1 wherein the obtained digital image includes a plurality of pixels and the method includes measuring, for a test area of pixels within the obtained digital image, a physical characteristic of each pixel and comparing the measured physical characteristic of each pixel within the test area with the measured physical characteristic of an adjacent pixel.

4. A method according to claim 1 wherein the physical characteristic measured is a luminance of each pixel.

5. A method according to claim 1 including the step of comparing the measured physical characteristic of each pixel within the test area with the measured physical characteristic of two or more adjacent pixels.

6. A method according to claim 1 wherein the test area of pixels within the obtained digital image includes a plurality of pixels in rows and columns and the method includes comparing the measured physical characteristic of each pixel within the test area with the measured physical characteristic of a first adjacent pixel located in the same row and with the measured physical characteristic of a second adjacent pixel located in the same column.

7. A method according to claim 6 including comparing the measured physical characteristic of each pixel within the test area with the measured physical characteristic of an adjacent pixel located in an adjacent row or column.

8. A method according to claim 1 include measuring for a test area of pixels within the obtained digital image, a physical characteristic of a group of adjacent pixels and comparing the measured physical characteristic of that group of pixels with the measured physical characteristic of an adjacent group of pixels.

9. A method according to claim 8 wherein the measured physical characteristic is an average luminance of each group of adjacent pixels.

10. A method according to claim 1 wherein, where the obtained digital image is a colour digital image, the method includes the step of converting the colour digital image to a gray-scale digital image before a physical characteristic of each pixel of the digital image is measured.

11. A method according to claim 10 including the step of measuring for the test area of the digital image the average pixel luminance value and the standard deviation of the luminance values for all of the pixels in the test area.

12. A method according to claim 1 wherein, the obtained digital image is a colour digital image, the method includes the step of the separating the colour digital image into each of its component parts to produce three separate gray-scale digital images.

13. A method according to claim 12 including the step of measuring for the test area of each of the component part gray-scale digital images the average pixel luminance value and the standard deviation of the luminance values for all of the pixels in the test area.

14. A method according to claim 13 including the subsequent step of selecting for further analysis the component part gray-scale digital image with the largest pixel luminance standard deviation.

15. A method according to claim 12 wherein the Blue light component part gray-scale digital image is not used for further analysis if the substrate contains a brightening agent.

16. A method according to claim 10 including the step of enhancing the gray-scale digital image.

17. A method according to claim 16 wherein the luminance value for each pixel within the test area of the gray-scale digital image is adjusted if the luminance value of that pixel differs from an average luminance value for all of the pixels within the test area of the gray-scale digital image.

18. A method according to claim 17 wherein the enhancement includes adjusting the luminance value of each pixel within the test are by a multiplying factor.

19. A method according to claim 18 wherein the multiplying factor is determined by the arithmetic distance of the luminance value of each pixel from the mean pixel luminance value of all of the pixels in the test area.

20. A method according to claim 16 including the step of adjusting the luminance value for each pixel in the test area so as to spread the pixel luminance values of all of the pixels in the test area substantially evenly throughout the visible range.

21. A method according to claim 16 including the step of providing on a viewable output a digital display of the enhanced gray-scale digital image.

22. A method according to any preceding claim including the step of providing a viewable output indicative of the quality of the printed image.

23. An image obtaining apparatus, the apparatus including: —
a device to obtain a digital image of a portion of a surface of a substrate;
a storage device to store information relating to the obtained digital image; and
a device to measure one or more physical characteristics of the obtained digital image so as to provide information indicative of the quality of the substrate, wherein the apparatus also includes a light source for illuminating the portion of the surface of the substrate, so as to cast shadows over the surface of the substrate at or near regions of the surface of the substrate which are uneven.

24. (canceled)

25. (canceled)

26. (canceled)

27. (canceled)
